(19) United States
(12) Patent Application Publication
(10) Pub. No.: US 2022/0173684 A1
(43) Pub. Date: Jun. 2, 2022

(54) ELECTRIC MOTOR DRIVING SYSTEM

(71) Applicant: LS ELECTRIC CO., LTD., Anyang-si, Gyeonggi-do (KR)

(72) Inventor: Hak Jun LEE, Anyang-si, Gyeonggi-do (KR)

(21) Appl. No.: 17/598,055

(22) PCT Filed: Aug. 13, 2019
(86) PCT No.: PCT/KR2019/010318

§ 371 Date: Sep. 24, 2021

(30) Foreign Application Priority Data
Mar. 26, 2019 (KR) 10-2019-0034518

(51) Int. Cl. H02P 21/13; H02P 21/22

(52) U.S. Cl. CPC H02P 21/13; H02P 21/22

(57) ABSTRACT

Disclosed is an electric motor driving system. A system according to an embodiment of the present invention includes: a speed control unit for outputting a current command through a proportional-integral control applying a proportional gain and a first integral gain from a difference between a speed command of an electric motor and a feedback speed of the electric motor; a speed command generation unit for outputting the speed command using a sine function in which the amplitude of the speed command and the speed control bandwidth are frequencies; and a gain changing unit for adjusting the proportional gain and the first integral gain so that the phase difference between the speed command and the feedback speed is substantially

$$\frac{π}{4} .$$

### CROSS-REFERENCE TO RELATED APPLICATIONS

The present application is a National Stage of International Application No. PCT/KR2019/010318 filed on Aug. 13, 2019, which claims the benefit of Korean Patent Application No. 10-2019-0034518, filed on Mar. 26, 2019, with the Korean Intellectual Property Office, the entire contents of each hereby incorporated by reference.

### FIELD

The present disclosure relates to an electric motor driving system.

### BACKGROUND

With the development of semiconductor technology for power, it has become relatively easy to implement a variable voltage variable frequency (VVVF) power supply by using a power device capable of high-speed switching. VVVF is mainly used in voltage-type inverters that generate an AC variable voltage source by inputting a DC voltage. Such voltage-type inverters are mainly used in energy storage systems (ESS), photovoltaic inverters (PV inverters), and electric motor driving technologies.

When an electric motor is driven, the rotation speed of the motor is determined by the load torque, so if you want to control the speed of the electric motor, you need to control the torque of the electric motor in the speed control system.

In the speed control system of an electric motor using a voltage-type inverter, the speed controller is usually composed of a simple proportional integrator, and the overall proportional integral gain of the proportional integrator requires the entire inertia information of the electric motor driving system.

In the conventional system, the gain of the speed controller depends on inertia, which is a mechanical constant. If the information of the system constant is incorrect, the speed controller may not satisfy the designed control bandwidth, which may deteriorate the speed control performance.

In general, when driving an electric motor with an inverter, inertia, which is a mechanical constant, is information that is difficult to obtain. Therefore, in order to obtain this, a process is required, such as a user directly measuring speed and torque through a measuring instrument to obtain inertia information, or separately adding a process for inertia estimation to the inverter operation. However, since the electric motor must operate stably for this purpose, there is a problem in that it is difficult to obtain accurate inertia information at the initial stage of operation of the electric motor.

### SUMMARY

The technical problem to be solved by the present disclosure is to provide an electric motor driving system for simply setting a proportional integral gain without using inertia information.

An electric motor driving system according to an embodiment of the present disclosure may include a speed control unit for outputting a current command through a proportional-integral control applying a proportional gain and a first integral gain from a difference between a speed command of an electric motor and a feedback speed of the electric motor; a speed command generation unit for outputting the speed command using a sine function in which the amplitude of the speed command and the speed control bandwidth are frequencies; and a gain changing unit for adjusting the proportional gain and the first integral gain so that the phase difference between the speed command and the feedback speed is substantially

$$\frac{π}{4} .$$

In an embodiment of the present disclosure, the speed control bandwidth may be a frequency at which the phase delay of the feedback speed is substantially

$$\frac{π}{4}$$

when a sine wave speed command is applied to the speed control unit.

In an embodiment of the present disclosure, the gain changing unit may include a phase changing unit for outputting a virtual d-axis first signal, and a virtual q-axis second signal having an orthogonal component with a phase delay of

$$- \frac{π}{2}$$

from the first signal, from the feedback speed and the speed control bandwidth; a first integrating unit for outputting a phase angle for rotational transformation from the speed control bandwidth; a rotational transformation unit for rotationally transforming the first signal and the second signal, respectively, using the phase angle and outputting a third signal and a fourth signal that are direct current; and an integral control unit that integrally controls the third and fourth signals by applying a second integral gain for speed control gain adjustment, and outputs an amount of change for speed control adjustment gain.

In an embodiment of the present disclosure, the phase changing unit may include a second order generalized integrator (SOGI).

In an embodiment of the present disclosure, the integral control unit may include an error determining unit for determining errors of the third and fourth signals; an integral gain applying unit for applying the second integral gain to the error; and a second integrating unit that integrates the output of the integral gain applying unit to output the amount of change.

The system according to the embodiment of the present disclosure may further include a first switch unit for switching the speed control unit and the speed command generation unit; a second switch unit for switching the speed control unit and the gain changing unit; and a control unit for outputting a control signal for controlling on or off of the first switch unit and the second switch unit.

In an embodiment of the present disclosure, the proportional gain may be

$${K}_{p} = 3 \frac{{T}_{rated}}{{ω}_{rm \_ rated}} ( K + Δ K )$$

and the first integral gain may be

$${K}_{i} = 0.2 {K}_{p} {ω}_{sc} = 0.2 \cdot 3 \frac{{T}_{rated}}{{ω}_{rm \_ rated}} ( K + Δ K ) {ω}_{sc}$$

wherein T_{rated} may be the rated torque of the electric motor, ω_{rm_rated} may be the rated speed of the electric motor, K may be the adjustment gain of the speed control unit, and ΔK may be the amount of change, so

$$Δ K = \frac{{K}_{sc}}{s} ( {ω}_{rm}^{de} - {ω}_{rm}^{qe} ) .$$

In addition, K_{sc} may be the second integral gain, ωᵣₘ^{de} may be the third signal, and ωᵣₘ^{qe} may be the fourth signal.

In addition, an electric motor driving system according to an embodiment of the present disclosure may include a speed control unit for outputting a current command through a proportional-integral control applying a proportional gain and a first integral gain from a difference between a speed command of an electric motor and a feedback speed of the electric motor; a speed command generation unit for outputting the speed command using a sine function in which the amplitude of the speed command and the speed control bandwidth are frequencies; and a gain changing unit for adjusting the proportional gain and the first integral gain so that the magnitude of the feedback speed is substantially

$$\frac{1}{\sqrt{2}}$$

compared to the magnitude of the speed command.

In an embodiment of the present disclosure, the speed control bandwidth may be a frequency at which the magnitude of the feedback speed is substantially

$$\frac{1}{\sqrt{2}}$$

compared to the magnitude of the speed command when a sine wave command is applied to the speed control unit.

In an embodiment of the present disclosure, the gain changing unit may include a phase changing unit for outputting a virtual d-axis first signal, and a virtual q-axis second signal having an orthogonal component with a phase delay of

$$- \frac{π}{2}$$

from the first signal, from the feedback speed and the speed control bandwidth; a first integrating unit for outputting a phase angle for rotational transformation from the speed control bandwidth; a rotational transformation unit for rotationally transforming the first signal and the second signal, respectively, using the phase angle and outputting a third signal and a fourth signal that are direct current; a first multiplication unit for outputting a product of the third signal and the third signal; a second multiplication unit for outputting a product of the fourth signal and the fourth signal; an addition unit for adding outputs of the first multiplication unit and the second multiplication unit; an integral control unit that integrally controls the output of the addition unit and

$$\frac{{ω}_{m}}{2}$$

(where ωₘ is the amplitude of the speed command) by applying a second integral gain for speed control gain adjustment, and outputs an amount of change for speed control adjustment gain.

In an embodiment of the present disclosure, the phase changing unit may include SOGI.

In an embodiment of the present disclosure, the integral control unit may include an error determining unit for determining errors of the output of the addition unit and the

$$\frac{{ω}_{m}}{2} ;$$

an integral gain applying unit for applying the second integral gain to the error; and a second integrating unit that integrates the output of the integral gain applying unit to output the amount of change.

The system according to the embodiment of the present disclosure may further include a first switch unit for switching the speed control unit and the speed command generation unit; a second switch unit for switching the speed control unit and the gain changing unit; and a control unit for outputting a control signal for controlling on or off of the first switch unit and the second switch unit.

In an embodiment of the present disclosure, the proportional gain may be

$${K}_{p} = 3 \frac{{T}_{rated}}{{ω}_{rm \_ rated}} ( K + Δ K )$$

and the first integral gain may be

$${K}_{i} = 0.2 {K}_{p} {ω}_{sc} = 0.2 \cdot 3 \frac{{T}_{rated}}{{ω}_{rm \_ rated}} ( K + Δ K ) {ω}_{sc}$$

wherein T_{rated} may be the rated torque of the electric motor, ω_{rm_rated} may be the rated speed of the electric motor, K may be the adjustment gain of the speed control unit, and ΔK may be the amount of change, so

$$Δ K = \frac{{K}_{sc}}{2} ( \frac{{ω}_{m}}{2} - ( {ω}_{rm}^{de} \cdot {ω}_{rm}^{de} + {ω}_{rm}^{qe} \cdot {ω}_{rm}^{qe} ) ) .$$

In addition K_{sc} may be the second integral gain and ωᵣₘ^{de}·ωᵣₘ^{de}+ωᵣₘ^{qe}·ωᵣₘ^{qe} may be an out of the addition unit.

The present disclosure as described above is capable of setting the optimum gain by setting the speed control gain through simply adjusting the speed control adjustment gain from the nameplate value of the electric motor without going through a separate measurement or estimation process.

### BRIEF DESCRIPTION OF THE DRAWINGS

The above and other aspects, features, and advantages of the present disclosure will become more apparent to those of ordinary skill in the art by describing embodiments thereof in detail with reference to the accompanying drawings, in which:

FIG. 1 is a block diagram of a general electric motor speed control system;

FIG. 2 is a detailed block diagram of the speed control unit of FIG. 1;

FIG. 3 is a block diagram of an electric motor driving system according to an embodiment of the present disclosure;

FIG. 4 is a detailed block diagram of the speed command generation unit of FIG. 3;

FIG. 5 is a detailed block diagram of a first embodiment of the gain changing unit of FIG. 3; and

FIG. 6 is a detailed block diagram of a second embodiment of the gain changing unit of FIG. 3.

### DETAILED DESCRIPTION

Hereinafter, in order to fully understand the configuration and effects of the present disclosure, preferred embodiments of the present disclosure will be described with reference to the accompanying drawings. However, the present disclosure is not limited to the embodiments disclosed below, and may be embodied in various forms and various modifications may be made. Rather, the description of the present disclosure is provided so that this disclosure will be thorough and complete and will fully convey the concept of the disclosure to those of ordinary skill in the art. In the accompanying drawings, the size of the elements is enlarged compared to actual ones for the convenience of description, and the ratio of each element may be exaggerated or reduced.

Terms such as ‘first’ and ‘second’ may be used to describe various elements, but, the above elements should not be limited by the terms above. The above terms may be used only for the purpose of distinguishing one element from another. For example, without departing from the scope of the present disclosure, ‘first element’ may be named ‘second element’ and similarly, ‘second element’ may also be named ‘first element.’ In addition, expressions in the singular include plural expressions unless explicitly expressed differently in context. Unless otherwise defined, terms used in the embodiments of the present disclosure may be interpreted as meanings commonly known to those of ordinary skill in the art.

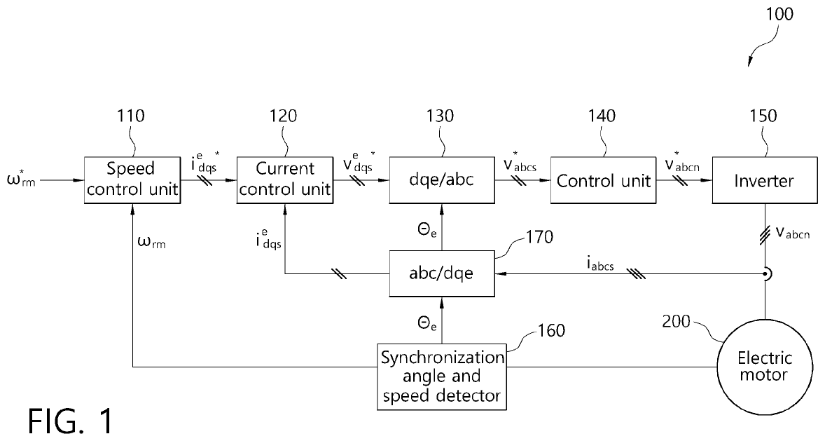

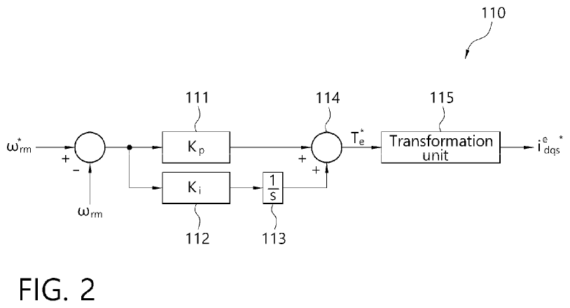

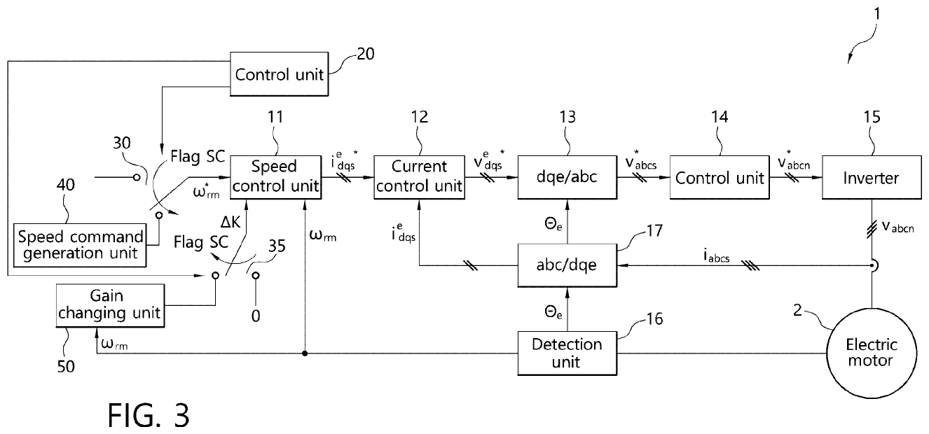

Hereinafter, a conventional electric motor driving system will be described with reference to FIGS. 1 and 2, and an electric motor driving system according to an embodiment of the present disclosure will be described with reference to FIGS. 3 to 6.

FIG. 1 is a block diagram of a general electric motor speed control system.

A speed control unit 110 measures a speed ωᵣₘ from a synchronization angle and speed detector (position sensor) 160 or a position estimator to follow a speed command ωᵣₘ* of an electric motor 200 and uses it for control, and outputs a synchronous coordinate system current command i_{dqs}^{e}* from the difference between the speed command and the measured speed.

A current control unit 120 measures current i_{dqs}^{e} of the d- and q-axes of the electric motor 200 to follow a synchronous coordinate system d- and q-axes's current i_{dqs}^{e}* that is an output of the speed control unit 110 and uses it for control, and outputs a synchronous coordinate system d- and q-axes voltage command v_{dqs}^{e}* from the difference between the current command and the measured current.

At this time, the current command can be expressed as a vector of

$${i}_{dqs}^{{e}^{*}} = [ \begin{matrix}{i}_{ds}^{{e}^{*}} \\ {i}_{qs}^{{e}^{*}}\end{matrix} ] ,$$

and the measured current can be expressed as a vector of

$${i}_{dqs}^{e} = [ \begin{matrix}{i}_{ds}^{e} \\ {i}_{qs}^{e}\end{matrix} ] .$$

A coordinate transformation unit 130 transforms the synchronous coordinate system d- and q-axes' physical quantities into abc physical quantities, and the coordinate transformation unit 170 transforms the abc physical quantities into the synchronous coordinate system d- and q-axes' physical quantities.

In order to change the input v_{dqs}^{e}* of the coordinate transformation unit 130 to v_{abcs}* the following equation is used. Below,

$${v}_{dqs}^{{e}^{*}} = [ \begin{matrix}{v}_{ds}^{{e}^{*}} \\ {v}_{qs}^{{e}^{*}}\end{matrix} ] and {v}_{abcs}^{*} = [ \begin{matrix}{v}_{as}^{*} \\ {v}_{bs}^{*} \\ {v}_{cs}^{*}\end{matrix} ] .$$

$$[ \begin{matrix}{v}_{as}^{*} \\ {v}_{bs}^{*} \\ {v}_{cs}^{*}\end{matrix} ] = [ \begin{matrix}1 & 0 \\ \frac{- 1}{2} & \frac{\sqrt{3}}{2} \\ - \frac{1}{2} & - \frac{\sqrt{3}}{2}\end{matrix} ] [ \begin{matrix}cos {θ}_{e} & - sin {θ}_{e} \\ sin {θ}_{e} & cos {θ}_{e}\end{matrix} ] [ \begin{matrix}{v}_{ds}^{{e}^{*}} \\ {v}_{qs}^{{e}^{*}}\end{matrix} ] \qquad [ Equation 1 ]$$

The angle θₑ used in Equation 1 above is an electrical angle detected from the synchronization angle and speed detector 160.

In addition, in order to change the input i_{abcs} of the coordinate transformation unit 170 to i_{dqs}^{e}, the below equation is used. Here,

$${i}_{dqs}^{e} = [ \begin{matrix}{i}_{ds}^{e} \\ {i}_{qs}^{e}\end{matrix} ] and$$

$${i}_{abcs} = [ \begin{matrix}{i}_{as} \\ {i}_{bs} \\ {i}_{cs}\end{matrix} ] .$$

$$[ \begin{matrix}{i}_{ds}^{e} \\ {i}_{qs}^{e}\end{matrix} ] = \frac{2}{3} [ \begin{matrix}cos {θ}_{e} & sin {θ}_{e} \\ - sin {θ}_{e} & cos {θ}_{e}\end{matrix} ] [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{i}_{as} \\ {i}_{bs} \\ {i}_{cs}\end{matrix} ] \qquad [ Equation 2 ]$$

The angle θₑ used in Equation 2 above is an electrical angle detected from the synchronization angle and speed detector 160.

A PWM control unit 140 performs pulse width modulation (PWM) by changing a voltage command v_{abcs}* of abc phase to an appropriate pole voltage command v_{abcn}*. Here,

$${v}_{abcn}^{*} = [ \begin{matrix}{v}_{an}^{*} \\ {v}_{bn}^{*} \\ {v}_{cn}^{*}\end{matrix} ] .$$

An inverter 150 synthesizes a pole voltage command v_{abcn}* formed by the PWM control unit 140 into a pole voltage. The pole voltage command v_{abcn}* is synthesized into an actual pole voltage v_{abcn} by the inverter 150. At this time,

$${v}_{abcn} = [ \begin{matrix}{v}_{an} \\ {v}_{bn} \\ {v}_{cn}\end{matrix} ] .$$

The synchronization angle and speed detector 160 is a position sensor/position estimator such as an encoder or resolver, and detects a synchronization angle and a speed to detect a mechanical speed ωᵣₘ used in the speed control unit 110 and an electrical angle θₑ for coordinate transformation used in the coordinate transformation units 130 and 170.

FIG. 2 is a detailed block diagram of the speed control unit 110 of FIG. 1.

The sum 114 of the errors of the speed command ωᵣₘ* and the measured speed ωᵣₘ of the electric motor and the value passed through the proportional controller 111 with proportional gain Kₚ and the integral controllers 112 and 113 with integral gain Kᵢ, respectively, is output to a torque command Tₑ*, and the torque command is transformed into a synchronous coordinate system d- and q-axes' current command i_{dqs}^{e}* by the transformation unit 115 and is output.

In the configuration of the speed control unit 110 as described above, the proportional integral gain is set through the following process.

A typical inertial system mechanical equation may be expressed as follows if the effect of friction force is ignored.

$${T}_{e} = J \frac{d {ω}_{rm}}{d t} \qquad [ Equation 3 ]$$

Here, Tₑ is the torque applied to the electric motor, and J is the inertia of the electric motor.

The transfer function of the proportional integral speed controller can be expressed as follows.

$${G}_{pi} ( s ) = {K}_{p} + \frac{{K}_{i}}{s} \qquad [ Equation 4 ]$$

Here, Kₚ is the proportional gain and Kᵢ is the integral gain.

Assuming that the dynamic characteristics of the current control unit 120 are sufficiently fast compared to the speed control unit 110, the gain of the current control unit 120 is approximated to 1, and assuming an ideal situation (Tₑ*=Tₑ) in which the torque of the electric motor 200 determined by the output current of the inverter 150 follows the torque command well, the speed control system can be represented by the following equation.

$$( {K}_{p} + \frac{{K}_{i}}{s} ) ( {ω}_{rm}^{*} - {ω}_{rm} ) = {T}_{e} = Js {ω}_{rm} \qquad [ Equation 5 ]$$

Summarizing Equation 5 above, the speed response to the speed command can be expressed as the following transfer function.

$$\frac{{ω}_{rm}}{{ω}_{rm}^{*}} = \frac{s {K}_{p} + {K}_{i}}{J {s}^{2} + s {K}_{p} + {K}_{i}} \qquad [ Equation 6 ]$$

When the bandwidth of the speed control unit 110 is set to ω_{sc} and is designed to be overdamped, the proportional gain and the integral gain can be obtained as shown in Equation 7 below.

$${K}_{p} = J {ω}_{sc} \\ {K}_{i} = {K}_{p} \frac{{ω}_{sc}}{5} \qquad [ Equation 7 ]$$

As described above, it can be seen that the gain of the speed control unit 110 depends on inertia, which is a mechanical constant of the electric motor driving system. Therefore, when the information of the system is incorrect, the speed control unit 110 does not satisfy the designed control bandwidth, and thus there is a problem in that the performance of the speed control is deteriorated.

In general, when an inverter drives an electric motor, inertia, which is a mechanical constant, is information that is difficult to obtain. To obtain this, the user must directly measure the speed and torque through a measuring instrument, or add a separate process for inertia estimation to the inverter operation. However, for this operation, the electric motor 200 must be operated stably to some extent, and this operation is difficult in the case of the initial operation.

In addition, when there is no inertia information, the gain of the speed control unit should be set by the user manually measuring speed, torque, etc. through a measuring instrument. Therefore, in speed control, the gain is important enough to influence the performance, but there is a problem in that it is difficult to set it easily.

In order to solve this problem, the present disclosure proposes a gain setting based on the inertia obtained using the control settling time, so that the user can easily set the speed control gain without additional inertia information. In addition, the present disclosure proposes a method of automatically adjusting the speed control gain based on the gain setting. With this, the present disclosure is for stably driving an electric motor.

First, a method for setting a speed control gain proposed in the present disclosure will be described.

Assuming that the inertia of the load is constant, the torque can be determined by the following equation.

$$T = J \frac{d ω}{d t} \qquad [ Equation 8 ]$$

If the time to reach the rated speed ω_{rm_rated} is defined as the settling time tₛ when the rated torque T_{rated} is applied, the inertia of the system can be determined as in Equation 9.

$$J = \frac{T}{\frac{d ω}{dt}} = \frac{{T}_{rated}}{\frac{{ω}_{rm\_rated}}{{t}_{s}}} = \frac{{T}_{rated}}{{ω}_{rm\_rated}} {t}_{s} \qquad [ Equation 9 ]$$

In consideration of the transfer function of Equation 6 above, the settling time tₛ is defined as follows.

$${t}_{s} = \frac{3 K}{{ω}_{sc}} \qquad [ Equation 10 ]$$

In Equation 10 above, K means the adjustment gain of the speed control unit, and ω_{sc} means the bandwidth of the speed control unit. According to an embodiment of the present disclosure, the user can simply change the gain of the speed control unit by adjusting the adjustment gain K of the speed control unit.

Meanwhile, when the inertia is obtained by substituting the settling time of Equation 10 into Equation 9, the following Equation is obtained.

$$T = \frac{{T}_{rated}}{{ω}_{rm\_rated}} {t}_{s} = \frac{{T}_{rated}}{{ω}_{rm\_rated}} \frac{3 K}{{ω}_{sc}} \qquad [ Equation 11 ]$$

By substituting the inertia of Equation 11 above into the gain of the speed control unit of Equation 7, the gain of the speed control unit may be defined as follows.

$$\begin{matrix}{K}_{p} = J {ω}_{sc} \\ = \frac{{T}_{rated}}{{ω}_{rm\_rated}} \frac{3 K}{{ω}_{sc}} {ω}_{sc} \\ = \frac{{T}_{rated} \cdot 3 \cdot K}{{ω}_{rm\_rated}}\end{matrix} \\ {K}_{i} = 0.2 \cdot {K}_{p} \cdot {ω}_{sc} \qquad [ Equation 12 ]$$

In Equation 12 above, Kₚ denotes the proportional gain, and Kᵢ denotes the integral gain.

The bandwidth of the speed control unit is usually a value given by the bandwidth of the current control unit, and the initial value of the adjustment gain K of the speed control unit may be obtained by considering the damping ratio of the system. Therefore, the user may configure the electric motor driving system simply by changing K in the given bandwidth of the speed control unit.

FIG. 3 is a block diagram of an electric motor driving system according to an embodiment of the present disclosure.

As shown in the figure, the electric motor driving system 1 of an embodiment of the present disclosure may include a speed control unit 11, a current control unit 12, a first transformation unit 13, a PWM control unit 14, an inverter 15, a detection unit 16, a second transformation unit 17, a control unit 20, first and second switch units 30 and 35, a speed command generation unit 40, and a gain changing unit 50.

The operations of the speed control unit 11, the current control unit 12, the first transformation unit 13, the PWM control unit 14, the inverter 15, the detection unit 16, the second transformation unit 17 are the same as described with reference to FIG. 1.

The speed control unit 11 may output a synchronous coordinate system current command i_{dqs}^{e}* from the difference between the speed command ωᵣₘ* of the electric motor 2 and the actual speed ωᵣₘ of the electric motor 2 detected by the detection unit 16.

The current control unit 12 may output a voltage command v_{dqs}^{e}* of the synchronous coordinate system d- and q-axes from the difference between the current command i_{dqs}^{e}* of the synchronous coordinate system d- and q-axes and the measured current i_{dqs}^{e} of the synchronous coordinate system d- and q-axes of the electric motor 2.

The first transformation unit 13 may transform v_{dqs}^{e}* into v_{abcs}* using Equation 1. In addition, the second transformation unit 17 may transform i_{abcs} into i_{dqs}^{e} using Equation 2.

The PWM control unit 14 may perform pulse width modulation (PWM) by changing a voltage command v_{abcs}* of abc phase to an appropriate pole voltage command v_{abcn}* and the inverter 15 may synthesize a pole voltage command v_{abcn}* formed by the PWM control unit 14 into a pole voltage.

The detection unit 16 may detect a synchronization angle and a speed of the electric motor 2, and provide them to the speed control unit 11, the first and second transformation units 13 and 17, and the gain changing unit 50.

The speed command generation unit 40 may generate a speed command for adjusting the gain of the speed control unit 11.

The gain changing unit 50 may receive the speed detected by the detection unit 16 and change K, which is an adjustment gain of the speed control unit 10.

The first and second switch units 30 and 35 may be turned on or off by the control flag FlagSC of the control unit 20, and when the first and second switch units 30 and 35 are on, the gain of the speed control unit 10 may be adjusted and output and when the first and second switch units 30 and 35 are off, the gain of the speed control unit 10 may be output in the same manner as in the conventional method of FIG. 1.

Specifically, when FlagSC is off, a speed command for driving the electric motor is input to the speed control unit 11, and when FlagSC is on, a speed command generated by the speed command generation unit 40 is input to the speed control unit 11.

In addition, when FlagSC is off, ΔK controlling the gain of the speed control unit 11 may be 0, and the gain of the speed control unit 11 may not be changed, but when FlagSC is on, ΔK may be output from the gain changing unit 50 to change the gain of the speed control unit 11.

That is, when FlagSC, which is a control signal provided by the control unit 20, is on, a speed command for adjusting the gain of the speed control unit 11 may be generated from the speed command generation unit 40, and the speed command may be applied to the speed control unit 11. In addition, by using the speed (feedback speed) of the electric motor 2 fed back from the detection unit 16, an amount of change ΔK of the adjustment gain of the speed control unit 11 is obtained, and ΔK may be used to change the gain of the speed control unit 11.

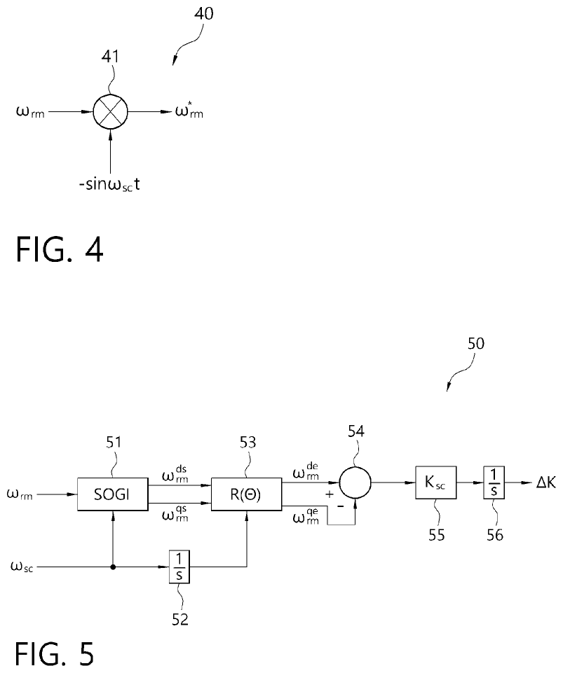

FIG. 4 is a detailed block diagram of the speed command generation unit of FIG. 3.

In the speed command generation unit according to an embodiment of the present disclosure, an amplitude ωₘ and a sine function −sin ω_{sc}^{t} of the speed command may be multiplied by a multiplication unit 41 and output as a speed command.

In this case, the sine function sin ω_{sc}t is multiplied so that the magnitude ωₘ of the speed command is shaken by the sine function, and the frequency of the sine function may be ω_{sc}, which is the set control bandwidth of the speed control unit 11. The speed command can be expressed as the following equation.

ωᵣₘ*=−ωₘ sin ω_{sc}t [Equation 13]

That is, the speed command may be generated in the form of a sine wave having an amplitude of ωₘ.

Meanwhile, the speed control bandwidth of the speed control unit 11 may be defined as a frequency at which the phase delay of the feedback speed is

$$\frac{π}{4}$$

when a sine wave command is applied. Therefore, when the sine wave command of Equation 13 is applied, the feedback speed can be defined as Equation 14.

$${ω}_{rm} = - {ω}_{fb} sin ( {ω}_{sc} t - \frac{π}{4} ) \qquad [ Equation 14 ]$$

In this case, ω_{fb} means the amplitude of the feedback speed.

The gain changing unit 50 may obtain the adjustment gain K of the speed control unit 11 at which the phase difference between the speed command and the feedback speed is

$$\frac{π}{4}$$

as shown in Equation 14.

FIG. 5 is a detailed block diagram of a first embodiment of the gain changing unit of FIG. 3.

As shown in the figure, the gain changing unit 50 of the first embodiment of the present disclosure may include a phase changing unit 51, a first integrating unit 52, a rotational transformation unit 53, an error determining unit 54, an integral gain applying unit 55, and a second integrating unit 56.

The phase changing unit 51 may receive the feedback speed and the set control bandwidth, and output a first signal ωᵣₘ^{ds} of the virtual d-axis and a second signal ωᵣₘ^{qs} of the virtual q-axis having an orthogonal component with a phase delay of

$$- \frac{π}{2}$$

from the first signal. In this case, the phase changing unit 51 may be, for example, a second order generalized integrator (SOGI). SOGI outputs a signal having an orthogonal component with a phase delay of

$$- \frac{π}{2}$$

when a sine wave is applied.

The signal output by the phase changing unit 51 is as follows.

$${ω}_{rm}^{ds} = - {ω}_{fb} sin ( {ω}_{sc} t - \frac{π}{4} ) \\ {ω}_{rm}^{qs} = {ω}_{fb} cos ( {ω}_{sc} t - \frac{π}{4} ) \qquad [ Equation 15 ]$$

However, in the embodiment of the present disclosure, SOGI is described by taking the configuration of the phase changing unit 51 as an example, but various circuits may be used to obtain the output signal of Equation 15 above.

As described above, the virtual d- and q-axes signals, which are AC signals of sine waves, may be transformed into DC components through rotational transformation.

The first and second signals of the virtual d and q axes, which are AC signals of sine waves, may be transformed into DC components through rotational transformation, and Equation 15 is expressed as an angle as follows.

$${ω}_{rm}^{ds} = - {ω}_{fb} sin ( {θ}_{sc} - \frac{π}{4} ) = - \frac{{ω}_{fb}}{\sqrt{2}} ( sin {θ}_{sc} - cos {θ}_{s c} ) \\ {ω}_{rm}^{qs} = {ω}_{fb} cos ( {θ}_{sc} - \frac{π}{4} ) = \frac{{ω}_{fb}}{\sqrt{2}} ( sin {θ}_{sc} + cos {θ}_{sc} ) \qquad [ Equation 16 ]$$

The first integrating unit 52 may integrate the control bandwidth to output the rotation angle of the sine wave command. This can be expressed as an equation as follows.

θ_{sc}∫_{sc}dt=ω_{sc}t [Equation 17]

When the rotational transformation is defined as in Equation 18 and the rotational transformation is applied to the AC signal of Equation 16, it can be transformed into a DC signal as shown in Equation 19 below, and is the same as the output of the rotational transformation unit 53. That is, the output signal

$$[ \begin{matrix}{ω}_{rm}^{ds} \\ {ω}_{rm}^{qs}\end{matrix} ]$$

of the phase changing unit 51 may be transformed into

$$[ \begin{matrix}{ω}_{rm}^{de} \\ {ω}_{rm}^{qe}\end{matrix} ]$$

by the rotational transformation unit 53.

$$\begin{matrix} R ( θ ) = [ \begin{matrix}cos θ & sin θ \\ - sin θ & cos θ\end{matrix} ] \\ & [ Equation 18 ] \\ [ \begin{matrix}{ω}_{rm}^{de} \\ {ω}_{rm}^{qe}\end{matrix} ] = R ( {θ}_{sc} ) [ \begin{matrix}{ω}_{rm}^{ds} \\ {ω}_{rm}^{qs}\end{matrix} ] = [ \begin{matrix}cos {θ}_{sc} & sin {θ}_{sc} \\ - sin {θ}_{sc} & cos {θ}_{sc}\end{matrix} ] [ \begin{matrix}- \frac{{ω}_{fb}}{\sqrt{2}} & ( sin {θ}_{sc} - cos {θ}_{sc} ) \\ \frac{{ω}_{fb}}{\sqrt{2}} & ( sin {θ}_{sc} + cos {θ}_{sc} )\end{matrix} ] = [ \begin{matrix}\frac{{ω}_{fb}}{\sqrt{2}} \\ \frac{{ω}_{fb}}{\sqrt{2}}\end{matrix} ] & [ Equation 19 ]\end{matrix}$$

Referring to Equation 19 above, when the phase delay is

$$\frac{π}{4} ,$$

it can be seen that the transformed DC signal

$$[ \begin{matrix}{ω}_{rm}^{de} \\ {ω}_{rm}^{qe}\end{matrix} ]$$

has the same value. In other words, if the output signal

$$[ \begin{matrix}{ω}_{rm}^{de} \\ {ω}_{rm}^{qe}\end{matrix} ]$$

of the rotational transformation unit 53 is the same value, the feedback speed means that the command speed and the phase delay are

$$\frac{π}{4} .$$

Accordingly, when the gain of the speed control unit 11 is adjusted so that

$$[ \begin{matrix}{ω}_{rm}^{de} \\ {ω}_{rm}^{qe}\end{matrix} ]$$

has the same speed, the speed control unit 11 satisfies the given speed control bandwidth, so that automatic adjustment is performed.

In an embodiment of the present disclosure, the speed control gain can be adjusted using the integral control. This can be expressed as Equation 20.

$$Δ K = \frac{{K}_{s c}}{s} ( {ω}_{rm}^{de} - {ω}_{rm}^{qe} ) \qquad [ Equation 20 ]$$

In this case, K_{sc} means the integral gain for speed control gain adjustment. As shown in Equation 20 above, an amount of change ΔK of the speed control adjustment gain can be generated so that

$$[ \begin{matrix}{ω}_{rm}^{de} \\ {ω}_{r m}^{q e}\end{matrix} ]$$

has the same value through the integral control. This may be accomplished by the error determining unit 54, the integral gain applying unit 55, and the integrating unit 56.

That is, the error determining unit 54 may determine the errors of the two DC signals ωᵣₘ^{de} and ωᵣₘ^{qe} of the rotational transformation unit 53, the integral gain applying unit 55 may apply the integral gain K_{sc} to the corresponding error, and the second integrating unit 56 may integrate it and output the amount of change ΔK of the speed control adjustment gain.

Again, the speed control unit 11 of FIG. 3 may receive the amount of change ΔK of the speed control adjustment gain generated in this way, and change the proportional integral gain as in Equation 21.

$${K}_{p} = 3 \frac{{T}_{r a t e d}}{{ω}_{rm \_ rated}} ( K + Δ K ) \\ {K}_{i} = 0.2 {K}_{p} {ω}_{sc} = 0.2 \cdot 3 \frac{{T}_{rated}}{{ω}_{rm \_ rated}} ( K + Δ K ) {ω}_{sc} \qquad [ Equation 21 ]$$

Meanwhile, in an embodiment of the present disclosure, the speed control bandwidth may be defined as a frequency at which the magnitude of the feedback speed is

$$\frac{1}{\sqrt{2}}$$

compared to the command when a sine wave command is applied. Therefore, when the sine wave command of Equation 13 is applied, the feedback speed can be defined as Equation 22.

ωᵣₘ=−ω_{fb} sin(ω_{sc}t−ϕ_{fb}) [Equation 22]

In Equation 22, ϕ_{fb} means the phase delay of the feedback speed, and ω_{fb}, which is the magnitude of the feedback speed, is ωₘ/\sqrt{2}, which is a magnitude that is

$$\frac{1}{\sqrt{2}}$$

compared to the command when the speed control bandwidth is satisfied.

When the feedback speed of Equation 22 is a virtual d-axis signal and an orthogonal component having a phase delay of

$$- \frac{π}{2}$$

from the corresponding speed is a virtual q-axis signal, it may be expressed as Equation 23.

ωᵣₘ^{ds}=−ω_{fb} sin(ω_{sc}t−ϕ_{fb})

ωᵣₘ^{qs}=ω_{fb} cos(ω_{sc}t−ϕ_{fb}) [Equation 23]

The virtual d- and q-axes signals, which are AC signals of sine waves, may be transformed into DC components through rotational transformation. Equation 23 is expressed as an angle as follows.

ωᵣₘ^{ds}=−ω_{fb} sin(ω_{sc}−ϕ_{fb})

ωᵣₘ^{qs}=ω_{fb} cos(ω_{sc}−ϕ_{fb}) [Equation 24]

When rotational transformation is applied to the AC signal of Equation 24 above, it can be transformed into a DC signal as shown in Equation 25.

$$[ \begin{matrix}{ω}_{rm}^{de} \\ {ω}_{r m}^{q e}\end{matrix} ] = R ( {θ}_{s c} ) [ \begin{matrix}{ω}_{rm}^{ds} \\ {ω}_{r m}^{q s}\end{matrix} ] = [ \begin{matrix}{cos θ}_{s c} & {sin θ}_{s c} \\ { sin θ}_{s c} & {cos θ}_{s c}\end{matrix} ] [ \begin{matrix}{ω}_{fb} sin ( {θ}_{s c} {ϕ}_{fb} ) \\ {ω}_{fb} cos ( {θ}_{s c} {ϕ}_{fb} )\end{matrix} ] = [ \begin{matrix}{ω}_{fb} {sin ϕ}_{fb} \\ {ω}_{fb} {cos ϕ}_{fb}\end{matrix} ] \qquad [ Equation 25 ]$$

From Equation 25 above, ω_{fb} can be obtained as Equation 26.

ω_{fb}=\sqrt{ωᵣₘ^{de}·ωᵣₘ^{de}+ωᵣₘ^{qe}·ωᵣₘ^{qe}} [Equation 26]

That is, since in ΔK satisfying the speed control bandwidth, ω_{fb} is

$$\frac{{ω}_{m}}{\sqrt{2}} ,$$

and in the corresponding condition, it can be expressed as Equation 27.

$${ω}_{rm}^{de} \cdot {ω}_{rm}^{de} + {ω}_{rm}^{qe} \cdot {ω}_{rm}^{qe} = \frac{{ω}_{m}}{2} \qquad [ Equation 27 ]$$

That is, when the gain of the speed control unit 11 is adjusted so that

$$\frac{{ω}_{m}}{2}$$

and ωᵣₘ^{de}·ωᵣₘ^{de}+ωᵣₘ^{qe}·ωᵣₘ^{qe} have the same value, the speed control unit 11 satisfies the given speed control bandwidth, so that automatic adjustment may be performed. Similarly, in an embodiment of the present disclosure, the speed control gain may be adjusted using the integral control, which can be expressed as Equation 28.

$$Δ K = \frac{{K}_{s c}}{s} ( \frac{{ω}_{m}}{2} - ( {ω}_{rm}^{de} \cdot {ω}_{rm}^{de} + {ω}_{rm}^{qe} \cdot {ω}_{rm}^{qe} ) ) \qquad [ Equation 28 ]$$

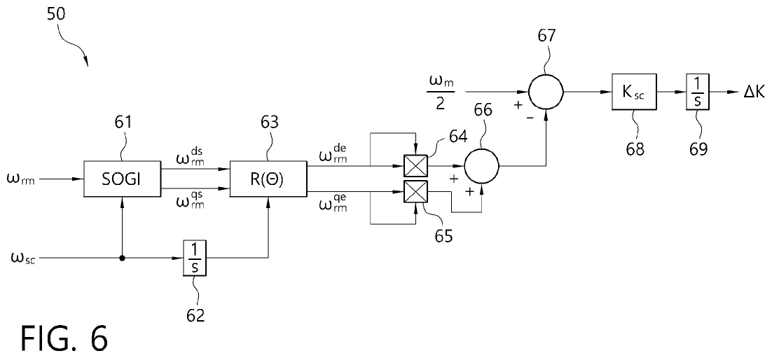

The above process is shown in FIG. 6. FIG. 6 is a detailed block diagram of a second embodiment of the gain changing unit of FIG. 3.

As shown in the figure, the gain changing unit 50 of the second embodiment of the present disclosure may include a phase changing unit 61, a first integrating unit 62, a rotational transformation unit 63, a first multiplication unit 64, a second multiplication unit 65, an addition unit 66, an error determining unit 67, and an integral gain applying unit 68, a second integrating unit 69.

In an embodiment of FIG. 6, ωᵣₘ is a feedback speed of the electric motor, and ω_{sc} is a preset speed control bandwidth.

The phase changing unit 61 may output a signal having a phase delay of

$$- \frac{π}{2}$$

when the feedback speed ωᵣₘ and the speed control bandwidth ω_{sc} of the electric motor 2 are inputs and a sine wave is applied. That is, in the second embodiment of the present disclosure, when the speed control bandwidth is defined as a frequency at which the magnitude of the feedback speed is

$$\frac{1}{\sqrt{2}}$$

compared to the command when a sine wave command is applied, the phase changing unit 61 may change and output the phase as in Equation 24.

The rotational transformation unit 63 may receive the phase angle θ_{sc} obtained by integrating the speed control bandwidth by the first integrating unit 62, and may rotationally transform the output of the phase changing unit 61 by the phase angle θ_{sc}. The output of the rotational transformation unit 63 is the same as Equation 25, and the output signal

$$[ \begin{matrix}{ω}_{rm}^{ds} \\ {ω}_{rm}^{q s}\end{matrix} ]$$

of the phase changing unit 61 may be transformed into

$$[ \begin{matrix}{ω}_{rm}^{de} \\ {ω}_{rm}^{q e}\end{matrix} ]$$

by the rotational transformation unit 63.

The first multiplication unit 64 and the second multiplication unit 65 may output ωᵣₘ^{de}·ωᵣₘ^{de} and ωᵣₘ^{qe}·ωᵣₘ^{qe}, respectively, and the addition unit 66 may output ωᵣₘ^{de}·ωᵣₘ^{de}+ωᵣₘ^{qe}·ωᵣₘ^{qe}, which is the sum of the first multiplication unit 64 and the second multiplication unit 65.

Thereafter, the error determining unit 67 may determine the errors of the output of the addition unit 66 and

$$\frac{{ω}_{m}}{2} ,$$

the integral gain applying unit 68 may apply the integral gain K_{sc} to the corresponding error, and the second integrating unit 69 may integrate it and output the amount of change ΔK of the speed control adjustment gain.

The speed control unit 11 may receive the amount of change ΔK of the adjustment gain of the speed control, and change the proportional integral gain as in Equation 21.

Unlike the conventional case in which the gain of the speed control unit is set through the measurement of speed and torque through a measuring instrument or set difficult through separate inertia estimation, according to an embodiment of the present disclosure, the speed control gain can be set by simply adjusting the speed control adjustment gain from the nameplate value of the electric motor without going through a separate measurement or estimation process.

That is, the present disclosure can easily set the speed control gain when the user initially drives the electric motor by using the gain obtained using the control settling time. In addition, the present disclosure can set the optimal speed control gain by automatically adjusting the speed control gain without a separate inertia estimation or measurement.

While the present disclosure has been described in connection with what is presently considered to be practical exemplary embodiments, those skilled in the art may understand that the disclosure is not limited to the disclosed embodiments, but, on the contrary, is intended to cover various modifications and equivalent arrangements included within the spirit and scope of the appended claims. Accordingly, the scope of the present disclosure shall be determined only according to the attached claims.

1. An electric motor driving system comprising:
a speed control unit for outputting a current command through a proportional-integral control applying a proportional gain and a first integral gain from a difference between a speed command of an electric motor and a feedback speed of the electric motor;
a speed command generation unit for outputting the speed command using a sine function in which the amplitude of the speed command and the speed control bandwidth are frequencies; and
a gain changing unit for adjusting the proportional gain and the first integral gain so that the phase difference between the speed command and the feedback speed is substantially
$$\frac{π}{4} .$$

2. The system of claim 1, wherein the speed control bandwidth is a frequency at which the phase delay of the feedback speed is substantially
$$\frac{π}{4}$$
when a sine wave speed command is applied to the speed control unit.

3. The system of claim 1, wherein the gain changing unit comprises:
a phase changing unit for outputting a virtual d-axis first signal, and a virtual q-axis second signal having an orthogonal component with a phase delay of
$$- \frac{π}{2}$$
from the first signal, from the feedback speed and the speed control bandwidth;
a first integrating unit for outputting a phase angle for rotational transformation from the speed control bandwidth;
a rotational transformation unit for rotationally transforming the first signal and the second signal, respectively, using the phase angle and outputting a third signal and a fourth signal that are direct current; and
an integral control unit that integrally controls the third and fourth signals by applying a second integral gain for speed control gain adjustment, and outputs an amount of change for speed control adjustment gain.

4. The system of claim 3, wherein the phase changing unit comprises a second order generalized integrator (SOGI).

5. The system of claim 3, wherein the integral control unit comprises:
an error determining unit for determining errors of the third and fourth signals;
an integral gain applying unit for applying the second integral gain to the error; and
a second integrating unit that integrates the output of the integral gain applying unit to output the amount of change.

6. The system of claim 1, further comprising:
a first switch unit for switching the speed control unit and the speed command generation unit;
a second switch unit for switching the speed control unit and the gain changing unit; and
a control unit for outputting a control signal for controlling on or off of the first switch unit and the second switch unit.

7. The system of claim 3, wherein the proportional gain is
$${K}_{p} = 3 \frac{{T}_{rated}}{{ω}_{rm \_ rated}} ( K + Δ K )$$
and the first integral gain is
$${K}_{i} = 0.2 {K}_{p} {ω}_{sc} = 0.2 \cdot 3 \frac{{T}_{rated}}{{ω}_{rm \_ rated}} ( K + Δ K ) {ω}_{sc} ,$$
wherein T_{rated} is the rated torque of the electric motor, ω_{rm_rated} is the rated speed of the electric motor, K is the adjustment gain of the speed control unit, and ΔK is the amount of change, so
$$Δ K = \frac{{K}_{sc}}{s} ( {ω}_{rm}^{de} - {ω}_{rm}^{qe} ) ;$$
and
K_{sc} is the second integral gain, ωᵣₘ^{de} is the third signal, and ωᵣₘ^{qe} is the fourth signal.

8. An electric motor driving system comprising:
a speed control unit for outputting a current command through a proportional-integral control applying a proportional gain and a first integral gain from a difference between a speed command of an electric motor and a feedback speed of the electric motor;
a speed command generation unit for outputting the speed command using a sine function in which the amplitude of the speed command and the speed control bandwidth are frequencies; and
a gain changing unit for adjusting the proportional gain and the first integral gain so that the magnitude of the feedback speed is substantially
$$\frac{1}{\sqrt{2}}$$
compared to the magnitude of the speed command.

9. The system of claim 8, wherein the speed control bandwidth is a frequency at which the magnitude of the feedback speed is substantially
$$\frac{1}{\sqrt{2}}$$
compared to the magnitude of the speed command when a sine wave command is applied to the speed control unit.

10. The system of claim 8, wherein the gain changing unit comprises:
a phase changing unit for outputting a virtual d-axis first signal, and a virtual q-axis second signal having an orthogonal component with a phase delay of
$$- \frac{π}{2}$$
from the first signal, from the feedback speed and the speed control bandwidth;
a first integrating unit for outputting a phase angle for rotational transformation from the speed control bandwidth;
a rotational transformation unit for rotationally transforming the first signal and the second signal, respectively, using the phase angle and outputting a third signal and a fourth signal that are direct current; and
a first multiplication unit for outputting a product of the third signal and the third signal;
a second multiplication unit for outputting a product of the fourth signal and the fourth signal;
an addition unit for adding outputs of the first multiplication unit and the second multiplication unit;
an integral control unit that integrally controls the output of the addition unit and
$$\frac{{ω}_{m}}{2}$$
(where ωₘ is the amplitude of the speed command) by applying a second integral gain for speed control gain adjustment, and outputs an amount of change for speed control adjustment gain.

11. The system of claim 10, wherein the phase changing unit comprises SOGI.

12. The system of claim 10, wherein the integral control unit comprises:
an error determining unit for determining errors of the output of the addition unit and the
$$\frac{{ω}_{m}}{2} ;$$
an integral gain applying unit for applying the second integral gain to the error; and
a second integrating unit that integrates the output of the integral gain applying unit to output the amount of change.

13. The system of claim 8, further comprising:
a first switch unit for switching the speed control unit and the speed command generation unit;
a second switch unit for switching the speed control unit and the gain changing unit; and
a control unit for outputting a control signal for controlling on or off of the first switch unit and the second switch unit.

14. The system of claim 10, wherein the proportional gain is
$${K}_{p} = 3 \frac{{T}_{rated}}{{ω}_{rm \_ rated}} ( K + Δ K )$$
and the first integral gain is
$${K}_{i} = 0.2 {K}_{p} {ω}_{sc} = 0.2 \cdot 3 \frac{{T}_{rated}}{{ω}_{rm \_ rated}} ( K + Δ K ) {ω}_{sc} ,$$
wherein T_{rated} is the rated torque of the electric motor, ω_{rm_rated} is the rated speed of the electric motor, K is the adjustment gain of the speed control unit, and ΔK is the amount of change, so
$$Δ K = \frac{{K}_{sc}}{s} ( \frac{{ω}_{m}}{2} - ( {ω}_{rm}^{de} \cdot {ω}_{rm}^{de} + {ω}_{rm}^{qe} \cdot {ω}_{rm}^{qe} ) ) ;$$
and
K_{sc} is the second integral gain and ωᵣₘ^{de}·ωᵣₘ^{de}+ωᵣₘ^{qe}·ωᵣₘ^{qe} is an out of the addition unit.
